(19) United States
(12) Patent Application Publication
(10) Pub. No.: US 2025/0249504 A1
(43) Pub. Date: Aug. 7, 2025

(54) RARE EARTH MAGNET AND METHOD FOR MANUFACTURING THE SAME

(71) Applicant: HONDA MOTOR CO., LTD., Tokyo (JP)

(72) Inventors: Akihito NINOMIYA, Saitama (JP); Yasutaka SHINTANI, Saitama (JP); Ibuki OTA, Saitama (JP)

(21) Appl. No.: 19/033,173

(22) Filed: Jan. 21, 2025

(30) Foreign Application Priority Data
Feb. 2, 2024 (JP) 2024-014685

(51) Int. Cl. B22F 1/16; B22F 1/145; B22F 3/02; H01F 1/06; H01F 41/02

(52) U.S. Cl. CPC B22F 1/16; B22F 1/145; B22F 3/02; H01F 1/061; H01F 41/0266; B22F 2302/45; B22F 2998/10

(57) ABSTRACT

Provided are a rare earth magnet and a method for manufacturing the same, which achieve both high magnetic properties and low eddy current loss. The rare earth magnet comprises coated magnet powder particles, each comprising a rare earth magnet powder particle and a coating of an insulating material on a surface thereof, wherein the insulating material contains nanoparticles, with which the rare earth magnet powder particle is coated. The method of manufacturing the rare earth magnet comprises a coating operation which includes adding an insulating material to the rare earth magnet powder particles, such that each coated magnet powder particle comprises a rare earth magnet powder particle and a coating of the insulating material on a surface thereof, wherein the coating operation comprises spraying a nanoparticle dispersion solution containing the nanoparticles and a binding agent, to the rare earth magnet powder particles that are caused to be tumbling and flowing.

### TECHNICAL FIELD

The present invention relates to a rare earth magnet and a method for manufacturing a rare earth magnet.

### BACKGROUND ART

In recent years, efforts directed toward realizing a low-carbon or a decarbonized society have become more active, and for vehicles, research and development related to electrification technology are also being conducted in order to reduce CO₂ emissions and to improve energy efficiency. Methods for improving energy efficiency include to improve the efficiency of motors used as power sources. Recently, rare earth magnets have been used more and more to improve motor efficiency. Since rare earth magnets are metallic magnets, their electrical resistance is generally low, which causes a problem that incorporating rare earth magnets into a motor increases eddy current loss, which reduces the efficiency of the motor. Various proposals have been made about how to reduce eddy current loss.

Patent Document 1 discloses a rare earth magnet capable of reducing eddy current losses, having rare earth magnet powder particles, each covered with a film-like coating layer containing rare earth oxides. Bond portions containing rare earth oxide particles are interposed between the coated rare earth magnet powder particles. A method of producing the rare earth magnet comprises conducting high temperature and pressure forming of a mixture of rare earth oxides and rare earth magnet powder particles coated with the rare earth oxides.

Patent Document 2 discloses a method of manufacturing a rare earth magnet comprising: mixing Nd—Fe—B magnet powder with an oxide such as CaO, and a nitride such as BN or a fluoride such as CaF₂ for the purpose of high electrical resistance; and processing a resulting mixture by hot plastic molding, to produce an anisotropic magnet.

Patent Document 3 discloses that a first method of manufacturing a rare earth magnet comprises: preparing isotropic rapid-cooled powder particles such as Nd—Fe—B magnet powder particles; mixing the isotropic rapid-cooled powder particles with a predetermined compound for forming insulating layers; processing the mixture by cold molding to produce a cold molded product (temporary molding); and processing the cold molded product by hot molding (densifying); and processing, by hot plastic molding, the resultant product (imparting anisotropy) to produce the rare earth magnet, and that a so-produced magnet includes generally stacked Nd—Fe—B rapid-cooled powder particles with the compound powder material therebetween, each particle having a long side length of 100 to 400 μm and a thickness of 20 to 40 μm.

### PRIOR ART DOCUMENT(S)

### Patent Documents(s)

Patent Document 1: JP4784173B
Patent Document 2: JP2003-022905A
Patent Document 3: JP2010-027852A

### SUMMARY OF THE INVENTION

### Task to be Accomplished by the Invention

In order to minimize the deterioration of magnetic properties of a rare earth magnet, it is desirable to reduce the amount of an insulating compound material to be mixed with magnet powder particles. However, since each of the magnet powder particles is flake-shaped, the magnet powder particles are generally stacked in the step of densifying the mixture of magnet powder particles and the insulating compound material. Thus, when performing the method of manufacturing a magnet of the prior art, the process of hot plastic molding (densifying) causes the magnet powder particles and the insulating compound material to deform and spread in directions perpendicular to a pressing direction (i.e., along main surfaces of the magnet powder particles). This means that a decreased amount of insulating compound material is likely to cause breaks in insulating layers during the process of hot plastic molding, thereby forming electrical connections between magnet powder particles, which should have been separated by the insulating layers. In such a case, a larger eddy current path (less effective in breaking up the eddy current path) is formed in the produced magnet, resulting in occurrence of a larger eddy current loss during operation of a motor using the magnet.

The present invention has been made in view of the above-described problem of the prior art, and a primary object of the present invention is to provide a rare earth magnet and a method for manufacturing the same, which achieve both high magnetic properties and low eddy current loss.

### Means to Accomplish the Task

As a solution to the above-described tasks to be accomplished, an aspect of the present invention provides a rare earth magnet (1) comprising coated magnet powder particles (5), each of which comprises a rare earth magnet powder particle (2) and a coating (4) of an insulating material on a surface thereof, wherein the insulating material contains nanoparticles, with which the rare earth magnet powder particle is coated.

In this configuration, as the insulating material contains nanoparticles, the coating formed on the surface of a rare earth magnet powder particle becomes thin and uniform, which prevents the occurrence of breaks in the coating. This allows the coated magnet powder particles to achieve both high magnetic properties and low eddy current loss.

Preferably, the above rare earth magnet may be further configured such that the nanoparticles are made of an alkali metal fluoride or an alkaline earth metal fluoride (CaF₂), and have particle sizes of 1 nm to 100 nm.

This configuration minimizes the reaction between the coating, which is formed of the alkali metal fluorides or alkaline earth metal fluoride, and a rear earth in the material of the rare earth magnet powder particles. This prevents the deterioration of magnetic properties of the rare earth magnet powder particles and that of insulating properties of the coating.

Preferably, the above rare earth magnet may be further configured such that the coating containing the nanoparticles has a thickness of 200 nm to 2000 nm.

In this configuration, nanoparticles form a plurality of layers, which prevents nanoparticles from being discrete to cause breaks in the coatings, and also prevents the occurrence of breaks in the coatings due to shortage of the nanoparticles during the molding operation for compressively deforming the coated magnet powder particles. This suppresses an increase in eddy current loss.

As a solution to the above-described tasks to be accomplished, another aspect of the present invention provides a method for manufacturing a rare earth magnet (1) comprising: performing a coating operation which includes adding an insulating material to rare earth magnetic powder particles (2) to produce coated magnet powder particles (5), such that each of the coated magnet powder particles comprises one of the rare earth magnet powder particles (2) and a coating (4) of the insulating material on a surface thereof (FIG. 1(B)); and performing a molding operation which includes placing the coated magnet powder particles in a mold configured to allow for pressurization, and applying pressure to the coated magnet powder particles in the mold, thereby compressively deforming the coated magnet powder particles to produce the rare earth magnet (FIG. 1(C) and 1(E)), wherein the insulating material contains nanoparticles, and wherein the coating operation comprises spraying a nanoparticle dispersion solution containing the nanoparticles and a binding agent, to the rare earth magnet powder particles that are caused to be tumbling and flowing, thereby adding the insulating material.

In this configuration, the coating operation, which comprises spraying a nanoparticle dispersion solution containing the nanoparticles and a binding agent, to the rare earth magnet powder particles that are caused to be tumbling and flowing, causes the coating formed on the surface of a rare earth magnet powder particle to become thin and uniform. This prevents the occurrence of breaks in the coating. This allows the coated magnet powder particles to achieve both high magnetic properties and low eddy current loss.

Preferably, the above method may be further configured such that the nanoparticle dispersion solution is prepared by mixing the nanoparticles made of an alkali metal fluoride or an alkaline earth metal fluoride and having particle sizes of 1nm to 100 nm, a solvent, and the binding agent.

This configuration ensures that the nanoparticles are evenly attached to the surfaces of rare earth magnet powder particles with the binding agent, preventing the nanoparticles from becoming discrete to cause breaks in the coatings. This configuration also suppresses the reaction of the alkaline earth metal fluoride or alkaline metal fluoride contained in the coatings with the rare earth that is a material of the rare earth magnet powder particles.

Preferably, the above method may be further configured such that the coating operation includes adding an insulating material to the magnetic powder particles so that the coatings of the rare earth magnet containing the nanoparticles have thicknesses of 200 nm to 2000 nm.

In this configuration, nanoparticles form a plurality of layers, which prevents nanoparticles from being discrete to cause breaks in the coatings, and also prevents the occurrence of breaks in the coatings due to shortage of the nanoparticles during the molding operation for compressively deforming the coated magnet powder particles. This suppresses an increase in eddy current loss.

Preferably, the above method may be further configured such that the binding agent is an acrylic binding agent that decomposes at a temperature below a heat input temperature during the molding operation.

This configuration ensures that the nanoparticles are attached to the surfaces of rare earth magnet powder particles, and prevents the binding agent from remaining as residues in the rare earth magnet.

Preferably, the above method may be further configured such that the molding operation comprises: performing a first molding operation which includes placing the coated magnet powder particles in the mold configured to allow for pressurization in a first direction, and applying pressure to the coated magnet powder particles in the mold in the first direction, thereby compressively deforming the coated magnet powder particles to produce a first molded product (FIG. 1(C)); and performing a second molding operation which includes applying pressure to the first molded product in second direction that intersects with the first direction, thereby plastically deforming the first molded product to produce the rare earth magnet (FIG. 1(E)).

In this configuration, in the second molding operation, when being compressed in the second direction, the coated magnet powder particles of the first molded product spread in the third direction which is perpendicular to the first and second directions. This prevents the thicknesses of the coatings on the main surfaces of the rare earth magnet powder particles (i.e., the thicknesses in the first direction) from easily becoming thinner. This further prevents the occurrence of breaks in the coatings, which suppresses an increase in eddy current loss. Thus, this configuration allows for a decrease in the amount of insulating material to be added, thereby minimizing the deterioration of magnetic properties of the rare earth magnet caused by the addition of the insulating material.

### Effect of the Invention

As described above, the present invention can be embodied as a rare earth magnet and a method for manufacturing the same, which achieve both high magnetic properties and low eddy current loss.

### BRIEF DESCRIPTION OF THE DRAWINGS

FIG. 1 is an explanatory diagram showing a method for manufacturing a rare earth magnet according to an embodiment of the present invention, and includes FIGS. 1(A) to 1(E);

FIG. 2 shows a schematic diagram of a tumble flow device;

FIG. 3 shows a schematic diagram of coated magnet powder particles;

FIG. 4 includes FIGS. 4A and 4B showing SEM images including nanoparticle coatings; SEM images including nanoparticle coatings;

FIG. 5 shows an SEM image of a cross-section of a first molded product of the rare earth magnet after the first molding operation;

FIG. 6 includes FIGS. 6A and 6B, where FIG. 6A shows schematic cross-sectional views of (1) a first molded product and (2) a second molded product, both with nanoparticle coatings of the present invention, and FIG. 6B shows schematic cross-sectional views of (1) a first molded product and (2) a second molded product, both with bulk coatings of a comparative example; and

FIG. 7 includes FIGS. 7A and 7B, where FIG. 7A is an SEM image showing nanoparticle coatings of the present invention, and FIG. 7B is an SEM image showing bulk coatings of the comparative example.

### DESCRIPTION OF THE PREFERRED EMBODIMENT(S)

Embodiments of the present invention will be described below, with reference to the appended drawings.

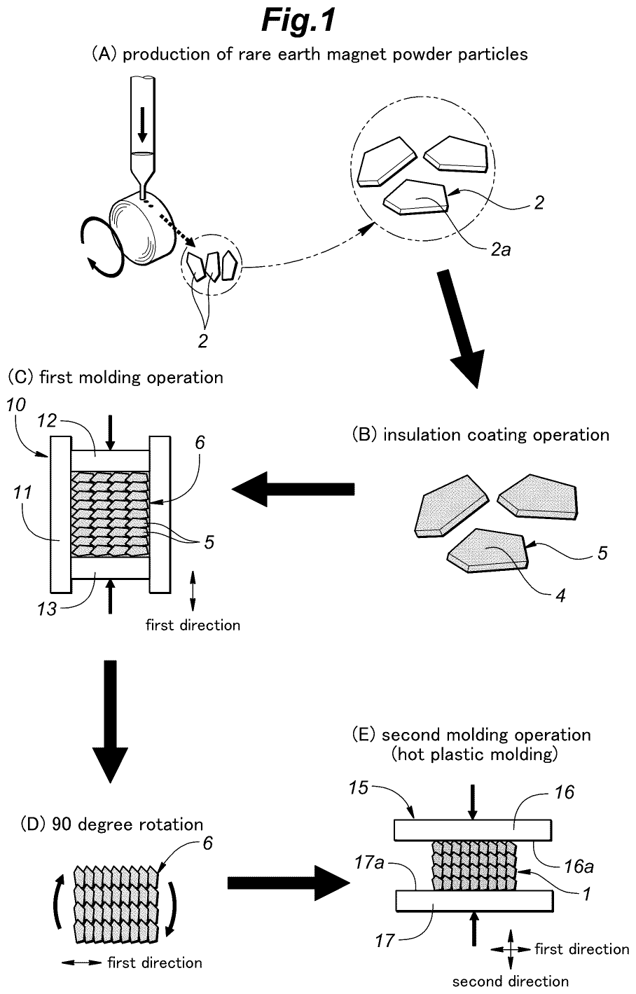

First, a manufacturing method of a rare earth magnet 1 of an embodiment of the present invention will be described below. FIG. 1 is an explanatory diagram showing a method for manufacturing a rare earth magnet of the embodiment of the present invention. As shown in FIG. 1(A), the first process is a step of producing rare earth magnet powder particles 2. This process produces rare earth magnet powder particles 2 to be used.

Examples of materials of the rare earth magnet powder particles 2 include, but not limited to, a neodymium magnet (Nd—Fe—B magnet, or more precisely Nd₂Fe₁₄B). An example of a method of manufacturing rare earth magnet powder particles 2 from a raw material of rare earth magnets is the melt spinning method. The melt spinning method includes spraying a high-temperature molten alloy onto a cooled roll for rapid cooling, thereby producing fine magnetic powder particles for magnets in the form of flakes (thin flakes) containing Nd—Fe—B crystals.

The rare earth magnet powder particles 2 produced in the process are isotropic rapid-cooled powder particles with non-aligned crystal directions, and each of the particles is flake-shaped, and thus has main surfaces 2a. The term “main surface 2a” is defined herein as each pair of the largest opposing flat surfaces. Each of the rare earth magnet powder particles 2 has an aspect ratio of approximately 1 (e.g., 0.7 to 1.0) when viewed from a direction perpendicular to the main surfaces 2a. The term “aspect ratio” refers to a ratio of the short diameter (minor axis diameter) to the long diameter (major axis diameter) of an object, and is expressed as b/a, where “a” is a long diameter and “b” is a short diameter. The term “major axis (major axis diameter)” refers to the maximum Feret diameter, and the term “minor axis (minor axis diameter)” refers to the minimum Feret diameter. The method for measuring the major and minor axes is compliant with the provisions of JIS Z 8890:2017 “Particle characterization of particulate systems.”

Next, as shown in FIG. 1(B), an insulation coating operation is performed to form an insulation coating on the surfaces of rare earth magnet powder particles 2. This operation involves adding an insulating material to rare earth magnet powder particles 2 so that a coating 4 is formed on a surface of each rare earth magnet powder particle 2, to thereby produce coated magnet powder particles 5 with the coatings 4 formed thereon.

Examples of preferable insulating materials include, but not limited to, alkali metal fluorides or alkaline earth metal fluorides. In the present embodiment, calcium fluoride (CaF₂), which is an alkaline earth metal fluoride, is used as the insulating material, but the insulating material is not limited to calcium fluoride. In some cases, the insulating material may be an alkaline earth metal fluoride (e.g., magnesium fluoride, barium fluoride, or strontium fluoride), an alkaline metal fluoride (e.g., lithium fluoride), or a combination (i.e., mixture) thereof.

A method for forming the coatings 4 on the surface of the rare earth magnet powder particles 2 includes mixing calcium fluoride nanoparticles with particle sizes of 1 nm to 100 nm and a binding agent with a solvent, and stirring the mixture to produce a nanoparticle dispersion solution. Examples of the solvent include, but not limited to, isopropyl alcohol (also known as 2-propanol or IPA). The binding agent is added to increase the binding between the rare earth magnet powder particles 2 and nanoparticles. The binding agent is preferably decomposed and removed by heating during a molding operation to produce a rare earth magnet 1. Thus, it is preferable to select, as a binding agent, a substance that exhibits good thermal decomposition, i.e., that decomposes at a temperature below a heat input temperature during the molding operation without leaving any residue after molding. In the present embodiment, an acrylic binding agent, which is a binding agent made from acrylic polymer, is used as the binding agent, but not limited thereto.

After the preparation of the nanoparticle dispersion solution, this method further includes adding the binding agent to the rare earth magnet powder particles 2 by spraying the nanoparticle dispersion solution containing the nanoparticles and the binding agent to the rare earth magnet powder particles 2 that are caused to be tumbling and flowing by using a tumble flow device 20.

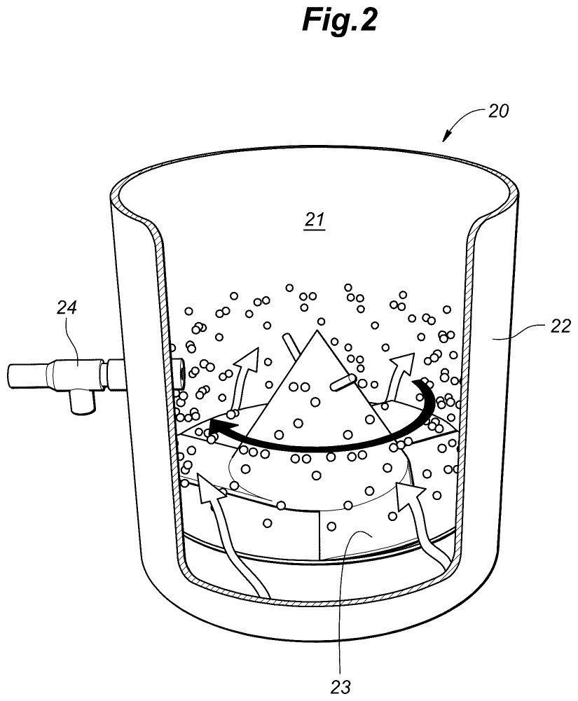

FIG. 2 shows a schematic diagram of a tumble flow device 20. As shown in FIG. 2, the tumble flow device 20 comprises a body housing 22 that defines a fluidized bed 21, a blade rotor 23 rotatably provided at a bottom of the fluidized bed 21, and a spray nozzle 24 provided on the lower side of the body housing 22. The spray nozzle 24 is attached to the body housing 22 in a horizontal orientation so that the nozzle faces downward towards the bottom of the fluidized bed 21 at a location above the blade rotor 23.

Air is supplied from the bottom of the body housing 22, and the rotation of the blade rotor 23 forces the rare earth magnet powder particles 2 to tumble and flow in the fluidized bed 21. With the air and the rare earth magnet powder particles 2 flowing in a swirling motion, the nanoparticle dispersion solution is sprayed from the spray nozzle 24 to the bottom of the fluidized bed 21, causing the surfaces of the rare earth magnet powder particles 2 to be coated with the nanoparticles in an efficient manner.

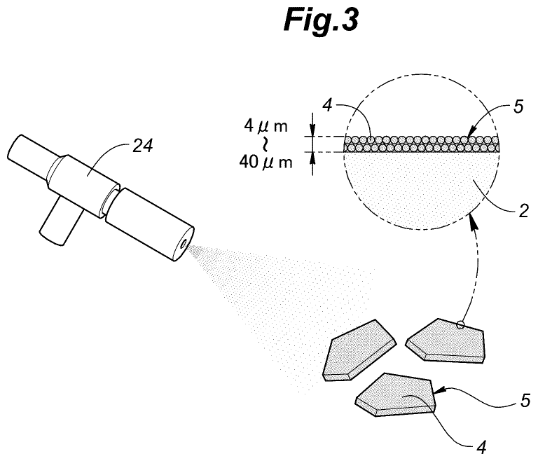

FIG. 3 shows a schematic diagram of coated magnet powder particles 5. As shown in FIG. 3, the insulation coating operation for producing coated magnet powder particles 5 includes adding the nanoparticle dispersion solution such that the coatings 4 having thicknesses of 1 μm to 40 μm are formed on the surfaces of rare earth magnet powder particles 2, thereby enabling the production of the rare earth magnet 1 in which the coatings 4 of the rare earth magnet powder particles 2 have thicknesses of 200 nm to 2,000 nm.

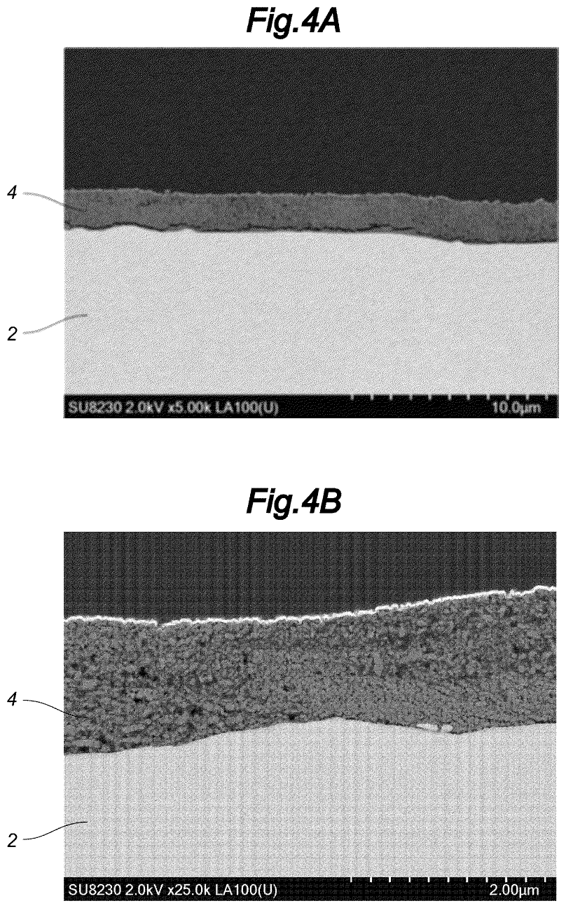

FIG. 4 shows SEM images including nanoparticle coatings. As described above, the nanoparticles for coatings have a particle size of 1 nm to 100 nm and form a coating having a thickness of 1 μm to 40 μm on the surface of the rare earth magnet powder particles 2.

Then, as shown in FIG. 1(C), a first molding operation for forming (molding) coated magnet powder particles 5 is performed. This operation includes placing the coated magnet powder particles 5 in the first mold 10 (hot press machine), and applying pressure to the coated magnet powder particles 5 with the first mold 10 in a first direction, thereby compressively deforming the coated magnet powder particles 5 to produce a first molded product 6 of the rare earth magnet 1 in which the coated magnet powder particles 5 have been densified.

The first mold 10 includes a cylindrical mold body 11 with a cross-sectional shape conforming to the shape of the first molded product 6, and an upper mold 12 and a lower mold 13 capable of applying a compressive force in the first direction to an object in the mold body 11. Thus, the first molding operation includes applying pressure to the coated magnet powder particles 5 while restricting deformation of the coated magnet powder particles 5 in a direction perpendicular to the first direction, thereby forming the first molded product 6. In the present embodiment, the first direction is a vertical direction, but is not limited thereto.

The first molding operation includes processing, by hot press molding, the coated magnet powder particles 5 into the first molded product 6, in which the first mold 10 is heated to a predetermined temperature and a predetermined pressure is applied for a predetermined time. When being compressively deformed by the pressure, the coated magnet powder particles 5 in the first mold 10 are oriented such that the main surfaces 2a of each of the rare earth magnet powder particles 2 face the first direction, resulting in that the coated magnet powder particles 5 are stacked on each other in the direction perpendicular to the main surface 2a (i.e., the first direction).

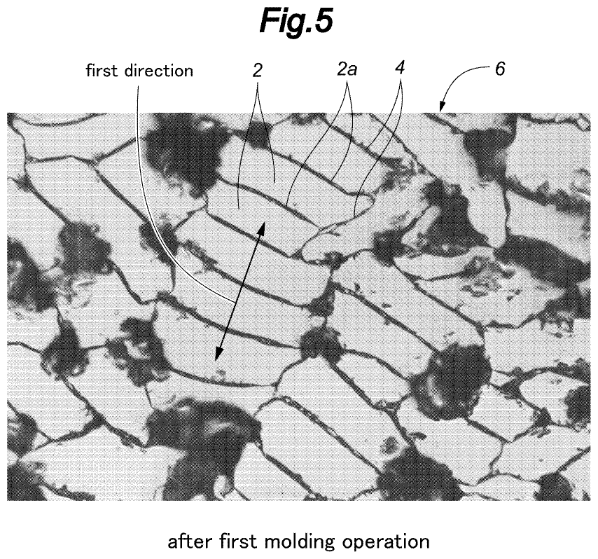

FIG. 5 shows an SEM image of a cross-section of the first molded product 6 of the rare earth magnet 1 after the first molding operation. As shown in FIG. 2, the first molded product 6 of the rare earth magnet 1 contains the rare earth magnet powder particles 2 that are stacked in a direction perpendicular to the main surface 2a (i.e., the first direction).

The first molding operation for forming the first molded product 6 is performed by using a process of hot compression, in which the coated magnet powder particles 5 are compressed and deformed at high temperatures, and the first mold 10 is heated to a predetermined temperature. The predetermined temperature is preferably a temperature within a range from about 600° C. to about 700° C., preferably 640° C.

After the first molding operation, a rotation operation is performed in which the resulting first molded product 6 is removed from the first mold 10 and rotated 90 degrees, as shown in FIG. 1(D). The rotation of the first molded product 6 is performed around an axis of rotation in the horizontal plane, i.e., around an axis parallel to the main surfaces 2a of each of the rare earth magnet powder particles 2.

In the present embodiment, the angle of rotation of the first molded product 6 is 90 degrees. Although the angle is not limited to 90 degrees, the angle of rotation is preferably close to 90 degrees, and more preferably 90 degrees, which is perpendicular to the first direction.

Then, as shown in FIG. 1(E), a second molding operation for molding the first molded product 6 is performed. This operation includes, after rotating the first molded product 6 to the angle as shown in FIG. 1(D), placing the first molded product 6 in a second mold 15, and applying pressure to the first molded product with the second mold 15 in a second direction, the second direction intersecting the first direction, which is the pressing direction in the first molding operation (i.e., the direction of stacking of the rare earth magnet powder particles 2), thereby plastically deforming the first molded product 6 to produce the rare earth magnet 1 (that is a second molded product).

The rotation operation shown in FIG. 1(D) is required since the pressing direction of the second molding operation shown in FIG. 1(E) is the same vertical direction as that of the first molding operation. Thus, in some cases, the rotation operation shown in FIG. 1(D) is not required when the pressing direction of the second molding operation is different from that of the first molding operation, e.g., when the pressing direction of the second molding operation is a horizontal direction.

The second mold 15 includes an upper mold 16 and a lower mold 17, which are opposite to each other. The upper mold 16 and lower mold 17 have an upper pressure surface 16a and a lower pressure surface 17a which conform to the shape of the first molded product 6 and are capable of applying pressure to the first molded product 6 in the second direction (vertical in the present embodiment). Since, in the present embodiment, the first molded product 6 has a rectangular shape, the upper mold 16 and the lower mold 17 have an upper pressure surface 16a and a lower pressure surface 17a, which are a pair of horizontal surfaces facing and parallel to each other, and configured to apply a compression force to the first molded product 6 in a vertical direction, which is perpendicular to the first direction.

The second molding operation includes pressing the first molded product 6 without restricting deformation of the first molded product 6 in the direction perpendicular to the second direction. Thus, in the second molding operation, the first molded product 6 is plastically deformed by compressing the first molded product 6 in the vertical direction, which is the pressing direction of the second molding operation, while allowing the first molded product 6 to deform in the horizontal direction perpendicular to the vertical direction. Specifically, for each of the rare earth magnet powder particles 2 in the rare earth magnet 1, the thickness (dimension in the first direction) becomes thicker than when being present in the first molded product 6 before the second molding operation. The aspect ratio of each of the rare earth magnet powder particle 2 in the rare earth magnet 1 viewed from the first direction becomes smaller than when being present in the first molded product 6 before the second molding operation. The aspect ratio of each of the rare earth magnet powder particles 2 in the rare earth magnet 1 is preferably smaller than 1, e.g., 0.15 to 0.5.

In the process of hot plastic molding, the rare earth magnet powder particles 2 of the first molded product 6 develop magnetic anisotropy (uniaxial anisotropy) with the c-axis directions (magnetization easy direction) of the crystal grains oriented parallel to the pressing direction. The rare earth magnet powder particles 2 of the rare earth magnet 1 are magnetized in the direction of this magnetic anisotropy.

In this way, in the second molding operation, the first molded product 6 is pressed in the second direction, which intersects the first direction, and plastically deformed. This causes the rare earth magnet powder particles 2 and the coating 4 around the particles to spread in the direction perpendicular to the second direction, i.e., the first direction and a third direction. In other words, the coating 4 between the rare earth magnet powder particles 2 adjacent to each other in the first direction becomes thinner by spreading in the third direction, while not spreading in the second direction. This prevents the coating 4 from becoming too thin in the first direction, which reduces an increase in eddy current loss. Details of this effect will be discussed later.

The second molding operation is performed by using a process of hot compression, in which the second mold 15 is heated to a predetermined temperature to compress and deform the first molded product 6, more specifically, by using a process of hot plastic molding, in which the first molded product 6 is plastically deformed at a higher temperature than the first molding operation. The temperature of the second mold 15 in the second molding operation is preferably a temperature at which some of the crystal grains of the rare earth magnet powder particles 2 undergo a phase change to the liquid phase, e.g., about 850 degrees. The process allows the rare earth magnet powder particles 2 to be plastically deformed with a high compaction rate. In the present embodiment, the first molded product 6 of the rare earth magnet 1 is plastically processed with a compaction rate of about 70% in the second molding operation.

Next, effects achieved by the rare earth magnet 1 manufactured as described above and by the method of manufacturing the same will be described, with reference to a comparative example.

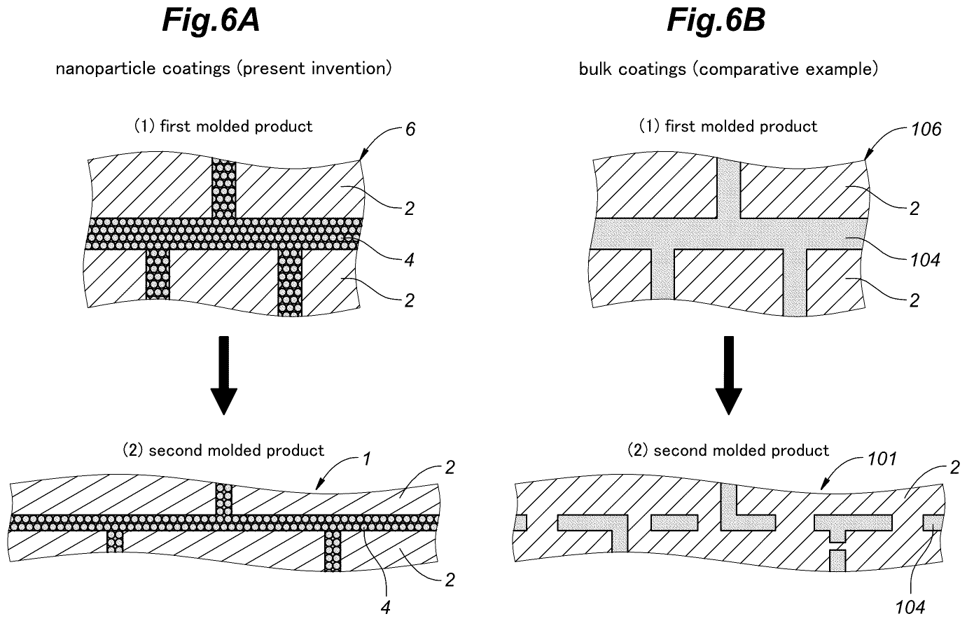

FIG. 6A shows schematic cross-sectional views of a first molded product 6 and a second molded product (rare earth magnet 1) both with nanoparticle coatings of the present invention, while FIG. 6B shows schematic cross-sectional views of a first molded product 106 and a second molded product (rare earth magnet 101) of a comparative example both with bulk coatings of a comparative example. First, the comparative example shown in FIG. 6B will be described. In manufacturing the rare earth magnet 101 (second molded product) of the comparative example, an insulation operation for forming coatings 104 is different from the insulation operation according to the embodiment of the present invention (FIG. 1(B)). The insulation operation for forming the coatings 104 may include, for example, sputtering or vapor deposition. The coatings 104 are insulating coatings applied in bulk, (also written simply as “bulk insulating coatings” or “bulk coatings”) each having a generally uniform thickness.

The process of manufacturing the rare earth magnet 101 of the comparative example includes a first molding operation (FIG. 1(C)) for producing a first molded product 106 in which the rare earth magnet powder particles 2 are stacked on each other in the direction perpendicular to the main surface 2a (i.e., the first direction), as shown in FIG. 6B(1). In the first molded product 106, the coating 104 forms an insulating layer with generally uniform thickness between rare earth magnet powder particles 2 that are adjacent to each other. In other words, the rare earth magnet powder particles 2 that are adjacent to each other are separated from each other by the coating 104 in the first molded product 106.

Subsequently, the second molding operation is performed on the first molded product 6 in which the first molded product 106 is pressed in the second direction (FIG. 1(E)) so that the rare earth magnet powder particles 2 and the coatings 104 spread along a plane perpendicular to the second direction (i.e. the plane including the left-right direction of the paper and in the direction perpendicular to the paper). This process produces the rare earth magnet 101 (or second molded product) of the comparative example as shown in FIG. 6B(2). During the second molding operation, the coating 104 is partially unable to follow the plastic deformation of the rare earth magnet powder particles 2, which spread along a plane perpendicular to the second direction, resulting in the occurrence of breaks in the coating. When pressure is applied in the second direction in this state, the rare earth magnet powder particles 2 that are adjacent to each other in the second direction are connected to each other at the points where breaks occur in the coating 104. This increases the volume of rare earth magnet powder particles, resulting in an increase in eddy current loss when a motor is operating.

In contrast, as shown in FIG. 6A(1), in the rare earth magnet 1 of the embodiment of the present invention, the coating 104 formed of nanoparticles forms an insulating layer with generally uniform thickness between rare earth magnet powder particles 2 that are adjacent to each other in the first molded product 106. During the second molding operation, as shown in FIG. 6A(2), the coating 104 can follow the plastic deformation of the rare earth magnet powder particles 2, which spread along a plane perpendicular to the second direction to become thinner, but without the occurrence of breaks in the coating.

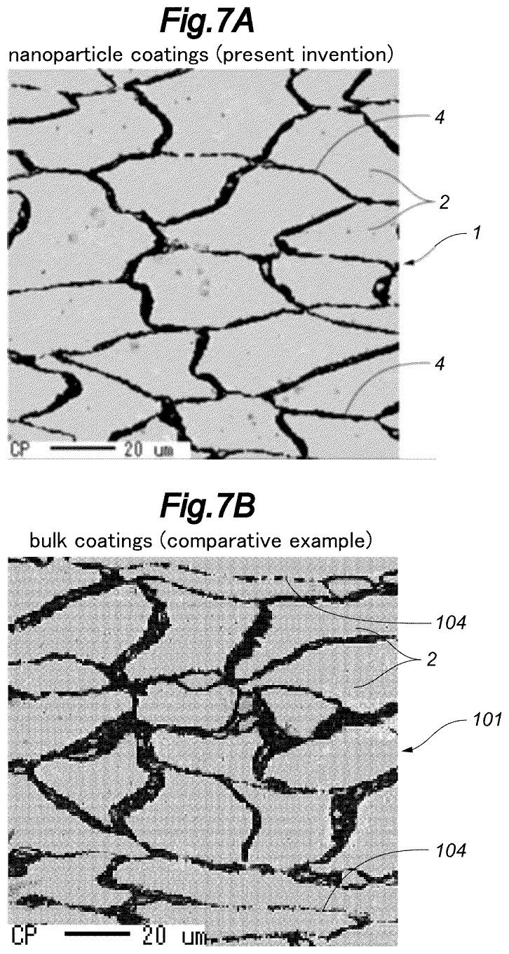

FIG. 7A is an SEM image showing nanoparticle coatings of the present invention, and FIG. 7B is an SEM image showing bulk coatings of the comparative example. As shown in FIG. 7B, in the rare earth magnet 101 with bulk coatings of the comparative example, the rare earth magnet powder particles 2 adjacent to each other in the vertical direction are connected to each other at breaks in the coating 104. In contrast, as shown in FIG. 7A, in the rare earth magnet 1 with the nanoparticle coatings of the present invention, the rare earth magnet powder particles 2 adjacent to each other in the vertical direction remain separate from each other by the coatings 4.

In the rare earth magnet 1 of the present invention, even after spreading in the second molding operation, the coatings 4 have generally uniform thicknesses in the range of 200 nm to 2000 nm.

In this way, a rare earth magnet 1 comprises coated magnet powder particles, each of which comprises a rare earth magnet powder particle 2 and a coating 4 of an insulating material on a surface thereof, wherein the insulating material contains nanoparticles, with which the rare earth magnet powder particle 2 is coated. In this configuration, as the insulating material contains nanoparticles, the coating 4 formed on the surface of a rare earth magnet powder particle 2 becomes thin and uniform, which prevents the occurrence of breaks in the coating 4. This allows the coated magnet powder particles 5 to achieve both high magnetic properties and low eddy current loss.

As described above, the nanoparticles are made of an alkali metal fluoride or an alkaline earth metal fluoride, and have particle sizes of 1 nm to 100 nm. This configuration minimizes the reaction between the coating 4, which is formed of the alkali metal fluorides or alkaline earth metal fluoride, and a rear earth in the material of the rare earth magnet powder particles 2. This prevents the deterioration of magnetic properties of the rare earth magnet powder particles 2 and that of insulating properties of the coating 4.

In the rare earth magnet 1, the coating 4 of the coated magnet powder particles 5 has a thickness of 200 nm to 2000 nm. In this configuration, nanoparticles in the coatings form a plurality of layers, which prevents nanoparticles from being discrete to cause breaks in the coatings 4, and also prevents the occurrence of breaks in the coatings 4 due to shortage of the nanoparticles during the molding operation for compressively deforming the coated magnet powder particles 5. This suppresses an increase in eddy current loss.

A method for manufacturing a rare earth magnet 1 comprises performing a coating operation which includes adding an insulating material to rare earth magnetic powder particles 2 to produce coated magnet powder particles 5 as shown in FIG. 1(B), wherein the insulating material contains nanoparticles. As shown in FIG. 2, the coating operation comprises spraying a nanoparticle dispersion solution containing the nanoparticles and a binding agent, to the rare earth magnet powder particles 2 that are caused to be tumbling and flowing, thereby adding the insulating material to rare earth magnetic powder particles 2. This coating operation causes the coating 4 formed on the surface of a rare earth magnet powder particle 2 to become thin and uniform. This prevents the occurrence of breaks in the coating 4 in the molding operations shown in FIG. 1(C) to 1(E)). This allows the coated magnet powder particles 5 to achieve both high magnetic properties and low eddy current loss.

As described above, the nanoparticle dispersion solution is prepared by mixing the nanoparticles made of an alkali metal fluoride or an alkaline earth metal fluoride and having particle sizes of 1 nm to 100 nm, a solvent, and the binding agent. This configuration ensures that the nanoparticles are evenly attached to the surfaces of rare earth magnet powder particles 2 with the binding agent, preventing the nanoparticles from becoming discrete to cause breaks in the coatings 4. This configuration also suppresses the reaction of the alkaline earth metal fluoride contained in the coatings 4 with the rare earth that is a material of the rare earth magnet powder particles 2.

The coating operation as shown in FIGS. 1(B) and 2 includes adding an insulating material to the magnetic powder particles to form thicker coatings 4 than the coatings 4 of the coated magnet powder particles 5 having thicknesses of 200 nm to 2000 nm in the resultant rare earth magnet 1. In this configuration, nanoparticles form a plurality of layers, which prevents nanoparticles from being discrete to cause breaks in the coatings 4, and also prevents the occurrence of breaks in the coatings 4 due to shortage of the nanoparticles during the molding operation for compressively deforming the coated magnet powder particles 5. This suppresses an increase in eddy current loss.

As described above, the binding agent is an acrylic binding agent that decomposes at a temperature below a heat input temperature during the molding operation, which ensures that the nanoparticles are attached to the surfaces of rare earth magnet powder particles 2, and prevents the binding agent from remaining as residues in the rare earth magnet 1.

As shown in FIG. 1, t the molding operation comprises: performing a first molding operation which includes applying pressure to the coated magnet powder particles 5 in the first direction, thereby compressively deforming the coated magnet powder particles 5 to produce a first molded product 6 (FIG. 1(C)); and performing a second molding operation which includes applying pressure to the first molded product 6 in second direction that intersects with the first direction, thereby plastically deforming the first molded product 6 to produce the rare earth magnet (FIG. 1(E)). In this configuration, in the second molding operation, when being compressed in the second direction, the coated magnet powder particles 5 of the first molded product spread in the third direction which is perpendicular to the first and second directions. This prevents the thicknesses of the coatings 4 on the main surfaces 2a of the rare earth magnet powder particles 2 (i.e., the thicknesses in the first direction) from easily becoming thinner. This further prevents the occurrence of breaks in the coatings 4, which suppresses an increase in eddy current loss. Thus, this configuration allows for a decrease in the amount of insulating material to be added, thereby minimizing the deterioration of magnetic properties of the rare earth magnet 1 caused by the addition of the insulating material.

Some embodiments of the present invention have been described. However, the present invention is not limited to those specific embodiments, and may be embodied with various modifications. For example, in the above embodiments, since the rare earth magnet 1 has a rectangular prismatic shape, the first molded product 6 is rotated by 90 degrees as shown in FIG. 1(D). However, as described earlier, the rotation angle is not limited to this angle. For example, when the first molded product 6 exhibits an octagon shape as viewed horizontally, the rotation angle may be 90 or 45 degrees. When the first molded product 6 exhibits a 16-sided polygon shape as viewed horizontally, the rotation angle may be any of 22.5, 45, 67.5 or 90 degrees. When the first molded product 6 exhibits a circular shape as viewed horizontally, the rotation angle may be any angle between 0 degree to 180 degrees. Generally, various changes and modifications may be made to features of the embodiments such as specific configuration, location, quantity, and material of each component or element in the embodiments without departing from the scope of the present invention. In the above-described embodiments, not all elements included therein are essential. Thus, various modifications including elimination of some elements may be made to the embodiments as appropriate.

### GLOSSARY

1 rare earth magnet
2 rare earth magnet powder particle
2a main surface
4 coating
5 coated magnet powder particle
6 first molded product
20 tumble flow device

1. A rare earth magnet comprising coated magnet powder particles, each of which comprises a rare earth magnet powder particle and a coating of an insulating material on a surface thereof,
wherein the insulating material contains nanoparticles, with which the rare earth magnet powder particle is coated.

2. The rare earth magnet as claimed in claim 1, wherein the nanoparticles are made of an alkali metal fluoride or an alkaline earth metal fluoride, and have particle sizes of 1 nm to 100 nm.

3. The rare earth magnet as claimed in claim 2, wherein the coating containing the nanoparticles has a thickness of 200 nm to 2000 nm.

4. A method for manufacturing a rare earth magnet comprising:
performing a coating operation which includes adding an insulating material to rare earth magnetic powder particles to produce coated magnet powder particles, such that each of the coated magnet powder particles comprises one of the rare earth magnet powder particles and a coating of the insulating material on a surface thereof; and
performing a molding operation which includes placing the coated magnet powder particles in a mold configured to allow for pressurization, and applying pressure to the coated magnet powder particles in the mold, thereby compressively deforming the coated magnet powder particles to produce the rare earth magnet,
wherein the insulating material contains nanoparticles, and
wherein the coating operation comprises spraying a nanoparticle dispersion solution containing the nanoparticles and a binding agent, to the rare earth magnet powder particles that are caused to be tumbling and flowing, thereby adding the insulating material.

5. The method as claimed in claim 4, wherein the nanoparticle dispersion solution is prepared by mixing the nanoparticles made of an alkali metal fluoride or an alkaline earth metal fluoride and having particle sizes of 1 nm to 100 nm, a solvent, and the binding agent.

6. The method as claimed in claim 5, wherein the coating operation includes adding the insulating material to the magnetic powder particles so that the coatings of the rare earth magnet containing the nanoparticles have thicknesses of 200nm to 2000 nm.

7. The method as claimed in claim 4, wherein the binding agent is an acrylic binding agent that decomposes at a temperature below a heat input temperature during the molding operation.

8. The method as claimed in claim 4, wherein the molding operation comprises:
performing a first molding operation which includes placing the coated magnet powder particles in the mold configured to allow for pressurization in a first direction, and applying pressure to the coated magnet powder particles in the mold in the first direction, thereby compressively deforming the coated magnet powder particles to produce a first molded product; and
performing a second molding operation which includes applying pressure to the first molded product in second direction that intersects with the first direction, thereby plastically deforming the first molded product to produce the rare earth magnet.
